(19) United States
(12) Patent Application Publication
(10) Pub. No.: US 2008/0284726 A1
(43) Pub. Date: Nov. 20, 2008

(54) System and Method for Sensory Based Media Control

(76) Inventor: Marc Boillot, Plantation, FL (US)

Correspondence Address: Marc Boillot, 9110 NW 11th Court, Plantation, FL, 33322, US

(21) Appl. No.: 12/120,654

(22) Filed: May 15, 2008

Related U.S. Application Data
(60) Provisional application No. 60/938,688, filed on May 17, 2007.

(51) Int. Cl. G09G 5/00

(52) U.S. Cl. 345/156

(57) ABSTRACT

An apparatus for sensory based media control is provided. A system that incorporates teachings of the present disclosure may include, for example, a media device having a controller element to receive from a media controller a first instruction to select an object in accordance with a physical handling of the media controller, and a second instruction to control the identified object or perform a search on the object in accordance with touchless finger movements. Additional embodiments are disclosed.

### CROSS-REFERENCE TO RELATED APPLICATION

This Application claims the priority benefit of Provisional Application No. 60/938,688 filed on May 17, 2007, the entire disclosure of which is incorporated herein by reference. This application also incorporates by reference the following Utility Applications: U.S. patent application Ser. No. 11/683,410 Attorney Docket No. B00.11 entitled “Method and System for Three-Dimensional Sensing” filed on Mar. 7, 2007 claiming priority on U.S. Provisional Application No. 60/779,868 filed Mar. 8, 2006, and U.S. patent application Ser. No. 11/683,415 Attorney Docket No. B00.14 entitled “Sensory User Interface” filed on Mar. 7, 2007 claiming priority on U.S. Patent Application No. 60/781,179 filed on Mar. 13, 2006.

### FIELD

The present embodiments of the invention generally relate to media systems, and more particularly to a system and method for sensory based media control.

### BACKGROUND

Media devices generally include a media controller, such as keyboard, mouse, touchpad, or stick for controlling an application of the media device. A user can interact with the application through the media controller. Prolonged use of a media controller or improper ergonomic handling can however lead to hand and finger fatigue.

A need therefore exists for a system and method for sensory based media control that facilitates user interaction.

### BRIEF DESCRIPTION OF THE DRAWINGS

FIG. 1 depicts an exemplary media system in accordance with one embodiment;

FIG. 2 depicts an exemplary embodiment of a media controller in accordance with one embodiment;

FIG. 3 presents a method for sensory based media control in accordance with one embodiment;

FIG. 4 presents an extension to the method in FIG. 3 in accordance with one embodiment;

FIG. 5 depicts a table of touchless finger signs in accordance with one embodiment;

FIG. 6 depicts another exemplary embodiment of a media system in accordance with one embodiment;

FIG. 7 presents a method for sensory based media control of an object in accordance with one embodiment;

FIG. 8 presents a method for touchless media selection in accordance with one embodiment;

FIG. 9 depicts another exemplary embodiment of a media system in accordance with one embodiment;

FIG. 10 presents a method for media searching in accordance with one embodiment;

FIG. 11 presents a method for adjusting media controls in accordance with one embodiment;

FIG. 12 depicts another exemplary embodiment of a media controller in accordance with one embodiment; and

FIG. 13 depicts yet another exemplary embodiment of a media system in accordance with one embodiment.

### DETAILED DESCRIPTION

Embodiments in accordance with the present disclosure provide a system and method for sensory based media control.

In a first embodiment, a method for touchless searching is provided that can include the steps of recognizing touchless finger signs responsive to a request for acquiring touchless control of at least a portion of an application, and controlling at least the portion of the application in accordance with the touchless finger signs. The request can be activated in response to a selection of an object in the application, or a positioning of a cursor over an object in the application. The application can be a web site, a gaming application, a programming guide, a computer program, a word processing program, an email application, a media control panel, a file management program, or an electronic programming guide. A media in the application can be searched responsive to recognizing the finger sign.

In a second embodiment, a media controller can include a tracking unit to detect a physical movement of the media controller and identify a component in an application, a sensing unit to detect touchless finger movements associated with the media controller, and a controller to control the component in the application in accordance with the touchless finger movements. In one arrangement, the tracking component can move a cursor in accordance with a physical handling of the media controller, and the touchless sensing unit can control an action of the cursor in accordance with the touchless finger movements. The tracking component can be an optical system, an opto-electric system, an acceleration detection system, a laser system, a track ball, a stick, or a touch-pad. The touchless sensing unit can project a touchless sensing space that is within a range of movement of an index finger when a user physically handles the media controller, and detect touchless finger signs for controlling a component action. The action can be a touchless scrolling, a touchless selection, or a touchless finger signing of an alphabetic or numeric character.

In a third embodiment a media controller can include a sensing unit to capture touchless finger signs, and a controller to recognize the touchless finger signs and control at least a portion of an application in accordance with the touchless finger signs. The media controller can be a mouse, a remote control, a mobile device, or a game control. In one arrangement, the controller can detect a movement of the media controller, select an object in accordance with the movement, recognize at least one finger sign after the movement stops, and search for a media in accordance with the at least one finger sign.

The controller can control a scrolling of a list in the application, a selection of an item in the list, a media control in the application, an object in the application, or a search operation in accordance with touchless finger signs. The application can include a list and the controller accesses items in the list in accordance with finger signs responsive to a selection of the list. The list can be a song list, an email list, a picture list, a message list, a contact list, a product list, a list of directories, or an address list. The application can include a media control panel that the controller adjusts in accordance with the touchless finger signs responsive to a selection of the media control. The controller can searches through a list in the application, change channels, or adjust a media control in accordance with the touchless finger signs.

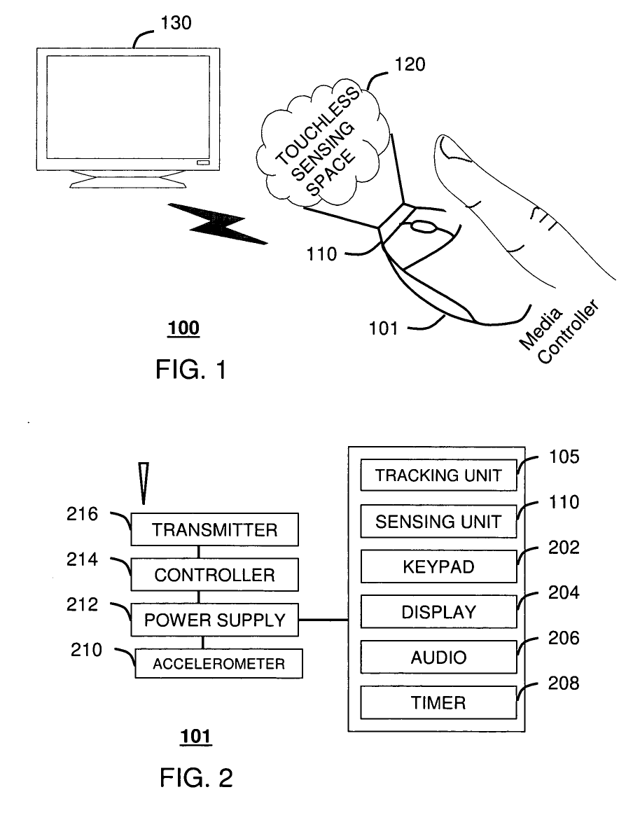

Referring to FIG. 1, a media system 100 in accordance with one embodiment is shown. The media system 100 can include a media controller 101 communicatively coupled to a media device 130. The media controller 101 can include a touchless sensing unit 110 that projects a touchless sensing space 120 within a range of movement of an index finger when a user physically handles the media controller 101. The touchless sensing unit 110 can be positioned at a front location of the media device, as shown, or in other locations. For example, the touchless sensing unit 110 can be placed peripheral on the sides of the media controller 110, or on a top surface of the media controller. In the arrangement shown, the media device 100 can include a left click button, a scroll control, and a right click button as shown, though more or less buttons or controls can be present. The media controller 101 can be a mouse, a remote controller, a gaming control, a mobile device, or any other user interface device or application control. The media device 130 can be a television, computer, laptop, set-top-box, a portable music system, a stereo, a digital television, or gaming console box that receives communications from the media controller 101.

FIG. 2 shows a block diagram of one or more components of the media controller 101. The media controller 101 can include a tracking unit 105 that can be an optical system, an opto-electric system, an acceleration detection system, a laser system, or any other tracking system. In one arrangement, the tracking unit 105 is internal to the media controller 101, and senses a physical movement of the media controller, for example, when the user slides the media controller 101 across a desktop surface. In another arrangement, the tracking unit 105 can detect movement in the air based on accelerated movements, for example, when the user raises the media controller and moves it around. The accelerometer 210 can detect accelerated left, right, forward, backward, up or down movements.

Optical components of the tracking unit 105 can also be aligned with the media device 130 to detect a location or movement of the media controller 101. For instance, a laser or infrared transmitter tracking unit 105 of the media controller 101 can be communicatively coupled to a receiver on the media device 130. The receiver on the media device 130 can track a movement of the media controller 101 in the air. For instance, the tracking unit 105 can transmit a signal to the receiver on the media device which can determine a location or movement of the media controller 101 from triangulation. The media controller 101 can also include a track ball, a stick, an alphanumeric key-pad, a touch-screen, or a touch-pad to communicate command requests to the media device, or any other networked device.

The media controller 110 includes the touchless sensing unit 110 shown in FIG. 1. The sensing unit 110 comprises sensors that detect a presence and movement of an object, such as the finger, in the touchless sensory space 120. The touchless sensing unit 110 does not require a transmitter or receiver to be attached to the finger, although materials with reflective cavities or shapes can be affixed to the finger to improve tracking. The touchless sensing unit 110 does not require a separation of a transmitter and receiver. The sensors can be infrared sensors, charge-coupled device sensors, surface acoustic wave sensors, laser elements, optical elements, camera elements or ultrasonic transducers. The touchless sensing unit 110 can generate the touchless sensing space 120 within a range of movement of an index finger when a user physically handles the media controller 101. The touchless sensing space 120 can also be an image field for capturing images, or pictures, of the finger motion. In such regard, the touchless sensing unit 110 does not necessarily project a sensing space 120, but presents an outline for identifying movement within the sensing space 120.

The media controller 101 can include a keypad 202 with depressible or touch sensitive navigation disk and keys spaced together or apart for manipulating operations of the media controller 101. This permits the controller 214 to coordinate touch-based finger movements (e.g., on the keypad) with touchless based finger movements (e.g., touchless scrolling actions). The media controller 101 can further include a display 204 such as monochrome or color LCD (Liquid Crystal Display) to present a user interface, an audio system 206 that presents audible sounds, and a timer 208 for monitoring control events. The media controller 101 can include an accelerometer 210 for determining a motion of the media controller 101 in response to physical handling. A power supply 212 can supply the components with power using a battery, through a standard power adapter, a Universal Serial Bus (USB) connection, or any other wired power source. The transmitter 216 can provide wireless or wired communication to the receiving media device 130, for example, using BlueTooth, WiFi, WiMAX, ZigBee, infrared, Clear, or any other wireless protocol. A controller 214 of the media controller 110 can utilize computing technologies such as a microprocessor and/or digital signal processor (DSP) with associated storage memory such a Flash, ROM, RAM, SRAM, DRAM or other like technologies for controlling operations of the aforementioned components of the media controller 110.

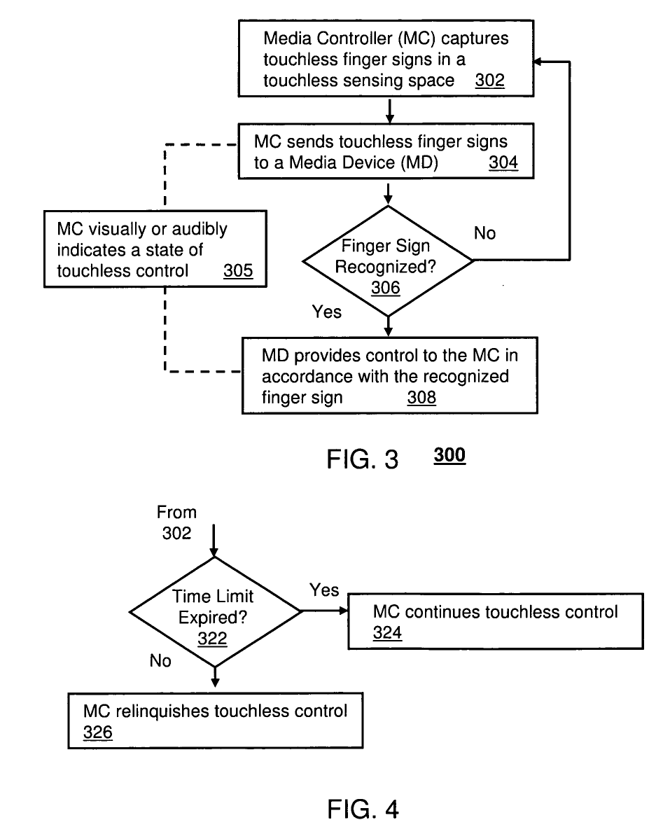

FIG. 3 depicts an exemplary method 300 operating in portions of the media system 100. More specifically, the method 300 illustrates a means for sensory based media control. The method 300 can be practiced with more or less than the number of steps shown. Moreover, the method 300 is not limited to the order of steps shown. Reference will be made to FIG. 1 when describing the method 300, although it should be noted that the method 300 can be practiced in any other suitable system.

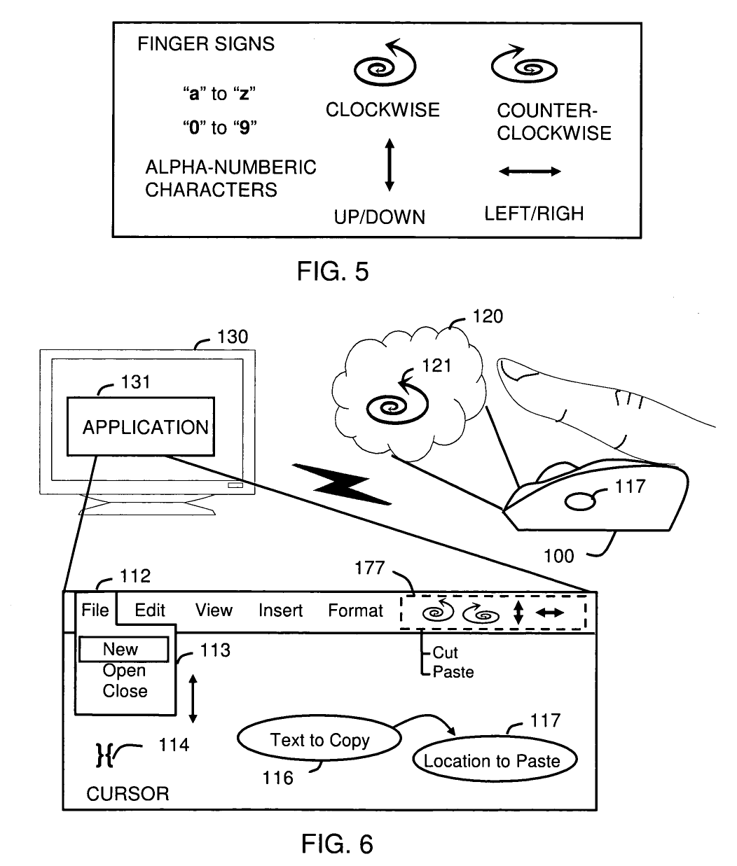

The method 300 can begin in step 302, in which the media controller 101 captures touchless finger signs in the touchless sensing space 120. The touchless finger sign can be an alphanumeric character, a clockwise circular movement, a counter-clockwise circular movement, an up/down movement, or a left/right movement as shown in FIG. 5. In step 304, the media controller 101 sends the touchless finger signs to the media device 130 or any other paired or networked component. For example, a user handling the media controller 101 can raise a finger while holding the media controller 101 to select and/or control at least a portion the media device 130.

At step 306, the media device 130 can recognize the finger sign, and provide the media controller 101 with partial or full control of the media device 130, as shown in step 308, in accordance with the recognized finger sign. For example, the user can physically move the media controller 101 in the air to select an object on the display, and then perform a touchless up/down finger movement in the touchless sensing space 120 to select the object in the display of the media device 130. So, instead of physically pressing an enter button on the media controller 101, the user can perform a touchless finger sign (e.g., up and down motion) in conjunction with a physical handling of the media controller 101. The media device 130 can respond with an acknowledgement that the object has been selected, for instance, by visually showing the entered selection. The media controller 101, or the media device 130, can recognize the finger sign, for example, using a neural network, vector quantizer, or other pattern classifier, for processing.

The media controller 101 can visually or audibly indicate a state of a touchless control, as shown in step 305. For example, the audio system 206 can emit a sound when a touchless finger sign is recognized, or when touchless control is acquired. Alternatively, the media controller 101 can direct the media device 130 to display the recognized finger sign or a visual cue for providing visual feedback. If the media device 130 does not recognize the finger sign, the media device 130 can inform the user that the finger sign was not recognized at step 310. For example, the media device 130 may audibly or visually indicate that a finger sign was attempted but not recognized. In another arrangement, the media controller 101 can inform the user that the media controller 101 did not recognize the finger sign, and provide a tactile feedback, such as a vibration movement. Alternatively, the media device 130 can be configured to not provide feedback, indirectly informing the user through an intentional lack of response that the control was not recognized.

Briefly, as shown in FIG. 4, the method 300 can include an expiration time for accepting a touchless finger sign. For example, upon the media device 130 receiving an indication that an object in the display has been selected, the media controller 101 can, at step 322, can determine if the user presented a finger sign within a time limit responsive to selecting the object by way of the timer 208. If the media controller 101 does not detect the finger sign within the time limit, the media controller 101 at step 326 can relinquish touchless control of the object. If the media controller 101 detects the finger sign within the time limit, the media controller 101 can provide touchless control of the object as shown in step 324.

FIG. 6 depicts an exemplary embodiment of the media system 100. As illustrated, a user operating the media controller 101 can control at least a portion of an application 131 presented by the media device 130 via touchless finger signing. In the example shown, the application 131 is a word processing program that includes a tool bar (e.g. File, Edit, View, etc) having an associated menu list 113 for each tool bar item, although any application is herein contemplated. As an example, the menu list 113 for the File tool 112 is shown. The menu list 113 can contain a list of menu items that can be selected and controlled by the user through conventional means (e.g. mouse control), physical movement (e.g., accelerated media controller 101 movements), or touchless control using finger signs 121.

The application can include a toolbar 177 for the touchless finger controls shown in FIG. 5. The toolbar 177 can receive a request to associate a finger sign with a function, and assign the function to the finger sign. A user can manually position the cursor 114 over the toolbar 177 to select a function associated with a touchless finger sign. As an example, the function can be a text editing operation such as a cut or paste, a font operation such as a bold or italic, or any other function. The function can also correspond to a macro, which is a sequence of commands, or functions. The toolbar 177 can have a menu list associated with each touchless finger sign that identifies the functions and/or macros available to the touchless finger sign, which can be customized for various operations. This allows for touchless finger commands to perform function commands. The media controller 101 allows the user to perform the macro with a single hand. The media controller 101 can further include a button 117 to initiate touchless finger control.

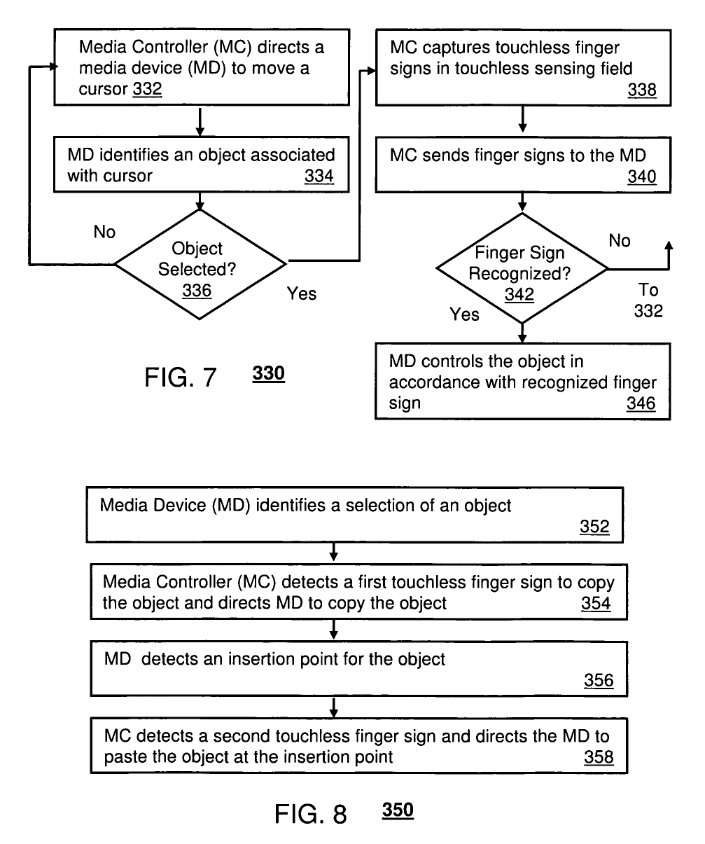

Referring to FIG. 7, a flowchart illustrating an exemplary method 330 of touchless control is shown. Reference will be made to FIG. 6 for describing the method 330. The method 330 can start in step 332, in which the media controller 101 directs the media device 130 to move the cursor 114 in accordance with the movement of the media controller. This occurs when the user physically moves the mouse to position the cursor 114 over an object.

At step 334, the mobile device 130 upon receiving a user directive identifies an object, such as the File tool 112, associated with cursor 114. The cursor may or may not be visually shown. When shown, the cursor may be a pointer sign, an arrow, or any other visual cue that identifies an association of the touchless finger movements with a position on the display of the media device 130. When the cursor is not shown, the media device 130 can identify an object in the display associate with the touchless finger movements. For instance, instead of seeing a cursor move responsive to touchless finger signs or movements, the user may see an activation of buttons or controls that can be acquired responsive to the touchless finger signs or movements.

Upon positioning the cursor 114 over the File tool 112 (or activating the File tool without a shown cursor), the user can click a media control button. Alternatively, the timer 208 can automatically perform the click in response to the positioning of the cursor 114. In response to the selection of the object at decision block 336, the media device 130 directs the application 131 to display the menu list 113 for the File tool.

At this point, the media controller 101 can capture touchless finger signs in touchless sensing field, as shown in step 338. In practice, the media controller 101 can monitor finger movements continuously even during physical moving of the media controller. As an example, upon seeing the menu list 113 displayed responsive to selecting the file tool 112, the user can perform a clockwise touchless finger sign to scroll through the menu list 113. The user can raise the finger and move the finger in the touchless sensing space 120 to scroll through the menu items. Briefly, touchless finger signing provides the user with a form of control that may be preferred by the user instead of manually touching the media controller. For example, instead of physically dragging the media controller to select a menu item thereby requiring physical movement of the hand, or physically manipulating (e.g. push down, slide back, lift up, reposition, etc) a scroll button with a finger on the media controller, the user can perform touchless finger signs that may be less physically demanding than the former control movements. Moreover, the media controller 101 can consolidate multiple functions singly without requiring a second hand at a keyboard. Furthermore, the scrolling action may be preferable when the menu lists presents numerous (>50) menu items.

At step 340, the media controller 101 can send the touchless finger signs to the media device 130. The media device 130 can then recognize the finger signs received at decision block 342. It should also be noted that the media controller 101 can recognize the finger sign locally and send the recognized finger sign to the media device 130. If the finger sign is not recognized, the media controller 101 can return back to step 332 to continue operation. If the finger sign is recognized, the media device 130 controls the object in accordance with recognized finger sign as shown in step 346.

For example, referring back to FIG. 6, the media controller 101 recognizes the clockwise touchless finger sign, and the media device 131 scrolls through the items in accordance with a continuing clockwise motion responsive to receiving the finger sign. Notably, once the finger sign is identified, the scrolling can continue in accordance with the finger movement. The user can also reverse the movement to scroll in the other direction. The user can proceed to pause the finger at a menu item of interest. Notably, the user can perform other finger signs for controlling one or more portions of the application 131, or operations of the media device 130. For example, to select an item, the user can perform a left/right finger sign, or hit a button on the media controller 101. The media controller 101 can be configured for multi-input operations.

FIG. 8 depicts another method 350 for touchless media control operating in portions of the media system 100. In particular, the method 350 provides an exemplary means for a touchless control action, such as a touchless copy and paste operation. Reference will be made to FIG. 6 when describing the method. The method 350 can start in a state where a user is working in a text document and desiring to copy and paste a section of text in the text document.

At step 352, the media device 130 identifies a selection of an object, such as a text selection. It should be noted that the object can be a file, a song, an email, a voice mail, a link, an icon, an image, or any other data source. For example, referring back to FIG. 6, the user can move the cursor 114 in accordance with a physical movement of the media controller 101, for example by way of the tracking unit 105, over a section of text 116. The user can then proceed to highlight the text 116, for example, by double clicking a left button on the media controller 101.

The media controller 101 can then proceed to detect a first touchless finger sign to copy the object responsive to the selection of the object, as shown in step 354. For example, after selecting the text 116, the user can perform a clockwise finger sign to signify a copy operation of the text. The user can then move the cursor 114 in accordance with a physical movement of the media controller 101 for example by way of the tracking unit 105 to another section 117 in the application.

At step 356, the media device 130 detects an insertion point of the object. For example, the user can click at the section 117 to indicate where the paste operation should occur. Upon identifying the insertion point, the user can perform a counter-clockwise finger sign to signify a paste operation of the text 116 into the section 117. This corresponds to step 358, wherein the media controller 101 detects a second touchless finger sign to paste the object at the insertion point.

Briefly, the finger signs can be used for different functions based on the application besides cut and paste, and the functions selected in the toolbar 177, or objects selected in response to a physical handling of the media controller 101 for example by way of the tracking unit 105. For instance, the user can physically motion the media controller 101 in air to select a list. (e.g., an accelerometer in the tracking unit 105 can detect physical movement). Upon activating the list, a clockwise finger sign can be used for scrolling the list, and cut/paste when an object is selected. Notably, the method 350 is not limited to copy and paste of only text selections.

The media device 130 and media controller 101 can operate cooperatively to perform touchless cut and paste operations for email applications, file management and database applications, and file sharing applications for copying and pasting music, photos, images, messages, and other forms of data. The method 350 can also be practiced directly by the media device 130, for example, if the media device 130 is a laptop, portable music player, security device, cell phone, or other suitable communication device, and the media controller 101 is an integrated component of the media device, such as a touchpad, a stick, a keypad, or a touch surface.

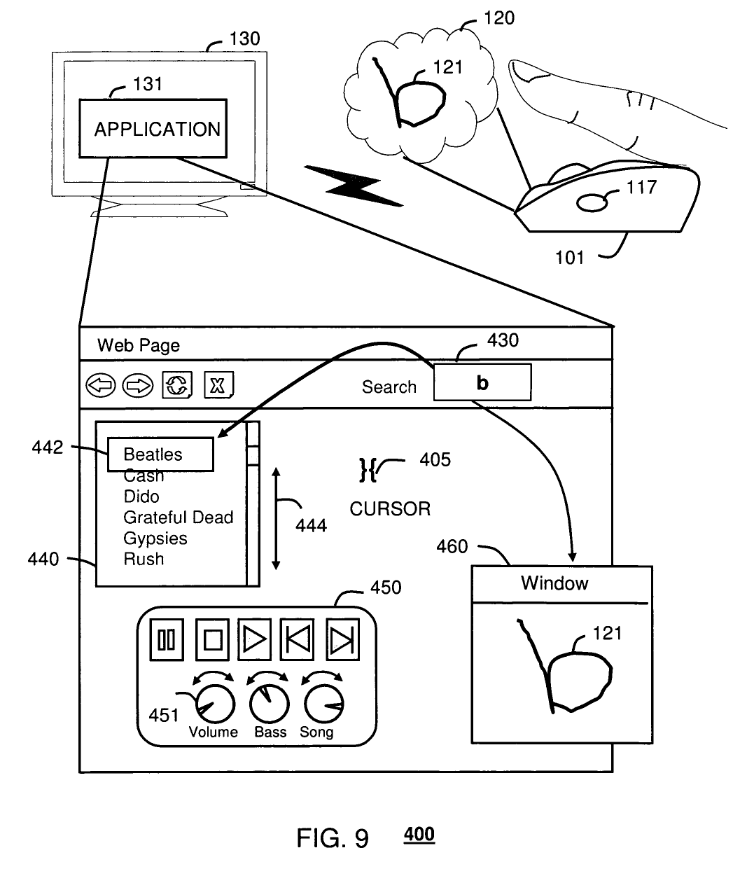

FIG. 9 depicts another exemplary embodiment 400 of the media system 100. As illustrated, a user operating the media controller 101 can control at least a portion of an application 131 presented by the media device 130 via a combination of physical handling of the media controller 101 and touchless finger signing with the media controller 101. As an example, the application 131 can be a web page hosted by a service provider that include, for illustration purposes, a search function 430 to receive text, a media list 440 to present media items 442, a media player 450 to play items selected in the media list 440, and one or more controls 451 that adjust the media player 450. The web page can be a channel selection guide for digital TV, internet TV, cable TV, satellite TV, digital radio, or any other broadcast media selection guide.

A user can enter a search string in the search function 430 to search for one or more media items in the media list 440 corresponding to the search string. In another arrangement, the search string can be used to identify words or phrases in a text portion of the web page. Notably, more or less than the number of controls can be present. The application can be a web site, a gaming application, a programming guide, a computer program, a word processing program, an email application, a media control panel, a file management program, an electronic programming guide, or any other user interface based program on a computer or mobile device. The application 420 can present a pop-up window 460 that conveys finger sign information, such as a trace of the finger sign in the touchless sensing space 120 and a corresponding recognized finger sign, such as an alpha-numeric character. The pop-up window 460 can also present visual status indicators for allowing a user to visually monitor finger sign movements.

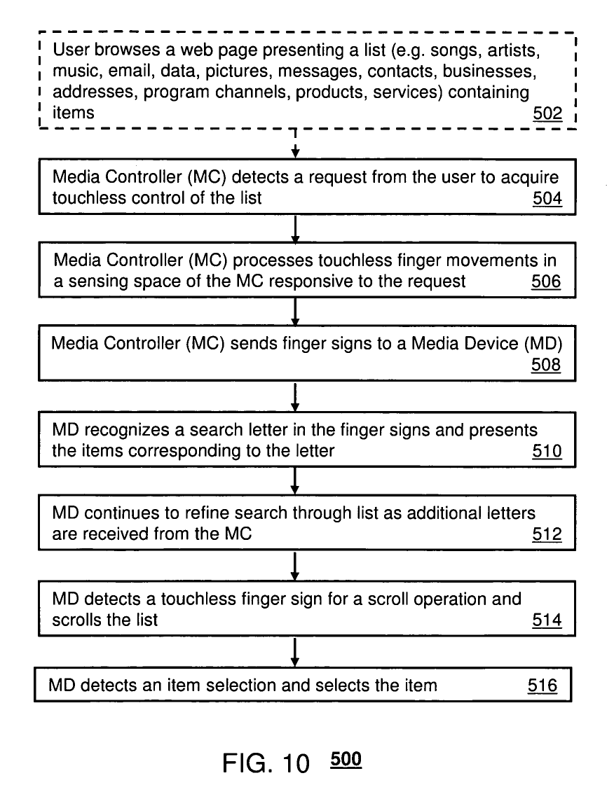

FIG. 10 presents an exemplary method 500 for sensory based media control. In particular, the method 500 provides an exemplary means for a touchless media selection. Reference will be made to FIG. 9 when describing the method 420. The method can begin at step 502, in which the user browses a web site presenting a list (e.g. songs, artists, music, email, data, pictures, messages, contacts, businesses, addresses, program channels, products, services) containing items. For example, as shown in FIG. 4, the web page 420 presents a media list 440 (e.g. music) of media items 442 (e.g. artists). In order to select a media item using touchless control, the user handling the media controller 101 can move the cursor 405 to the media list 440, such as within an activation zone, for example by way of physical movement of the media controller 101 in air. Alternatively, without a cursor, the user can navigate to components that are selected responsive to a user directive. The activation zone can include the interior and border of the media list 440.

At step 504, the Media Controller (MC) detects the positioning of the cursor, user interface component selection, or physical movement of the media controller 101, as a request from the user to acquire touchless control of the media list 440. In one aspect, the positioning of the cursor 405 in the media list 440 or component selection can constitute the request. Alternatively, the user can physically select (e.g. mouse click) at least a portion of the media list 440 to initiate the request. The request informs the media device 130 that touchless control has been requested.

In response, the media device 130 can extend control to the media controller 101, which allows the user to acquire touchless control of the media list 440. At step 506, the media controller 101 can process touchless finger movements in the touchless sensing space 120. For example, referring back to FIG. 4, the user can extend the finger above the media controller 101 to generate finger signs while handling the media controller 101. The controller 214 can include end point logic to distinguish between finger signs, such as characters or letters or symbols.

As one example, the user upon selecting the media list 440 can proceed to perform a touchless finger sign for a search string, to search through the media list 440 for media items corresponding to the search string. For example, the user can sign the letter “b” 121 to search for items in the media list (e.g. song list) that begin with “b”. The user can perform the finger sign 121 directly over the media list 440, and the media device 130 can direct the pop-up window 460 to indicate a status of the finger sign 121. For example, the media device 130 can present a visual trace of the finger sign 121 that is displayed it in the pop-up window 460 as the user performs the finger sign 121, thereby allowing the user to receive visual feedback for performing the finger sign 121. In another arrangement, the user can select the search function 430 directly, and enter the search string using touchless finger signs. In the former, the user can select any object available for searching to conduct the search. In the latter, the user selects a search function to perform the search.

At step 508, the media controller 101 sends finger signs to the media device 130. The media controller 101 can send the finger signs over a wired or wireless connection to the media device 130 for recognition and processing. At step 510, the media device 130 can recognize a search letter in the finger signs and present the items corresponding to the letter. Alternatively, the media controller 101 can recognize the finger signs and send the recognized finger sign (e.g. character, letter, or symbol) to the media device 130 for processing. To provide visual feedback, the media device 130 can direct the pop-up window 460 to display the finger sign 121 recognized.

In one arrangement, the media device 130, upon receiving the finger sign 121 and recognizing a letter, can enter the letter into the search function 430, which can search the media list 440 and order the media items in the media list beginning with the letter ‘b’. The media device 130 can arrange the list in alphabetical order, and automatically present the media items matching the search string. For example, upon recognizing the letter “b”, the media device 130 can present the menu items starting with the letter “b”.

At step 512, the media continues to refine search through list as more letters are received from the media controller 101. That is, the user can continue to submit touchless finger signs to narrow the search. For example, the user can sign the letter “e” to limit the search to those items beginning with “be”. The media device 130 can continue to direct the pop-up window 460 to indicate the finger sign or a status of the finger sign, and display the menu items matching the search string. The media device can also recognize finger signs for backspaces, and enters. For example, the media controller 101 can interpret left/right movements as an indication by the user to back track one character (e.g. delete a search string character), and interpret pauses as spaces (e.g. “ ” between words). This allows the user to control the search if a letter was incorrectly recognized or it the user wants to edit the search string in the search function 430.

Upon identifying a menu item selection, the user can revert to a scroll operation. At step 514, the media device detects a touchless finger sign for a scroll operation and scrolls the list. For example, one the user has narrowed the search, and only a few items 442 remain in the media list 440, the user can resort to touchless scrolling. In such regard, the user is not required to spell out the entire menu item using touchless finger signs. Touchless scrolling may be practical when the menu list 440 is extremely long. The media device 130 can scroll through list of narrowed down menu items in accordance with touchless finger scrolling signs. The media device 130 can stop scrolling when the user stops finger signing.

The user can then perform a touchless up/down finger sign to select the menu item. This corresponds to step 516 in which the media device detects an item selection and selects the item. Alternatively, the user can physically press a media control button to select the item. For example, the user can select the menu item “Beatles” when the media device has highlighted the selection in response to touchless scrolling.

The method 500 is not limited to searching a media list for media items as illustrated in FIG. 9. Although focus has been placed for illustration purposes on searching a media list using a combination of physical media controls (e.g. moving cursor, button presses) and touchless finger signs (e.g. letters, scrolling, selection), the method 500 can be applied in other contexts. For example, the method 500 can be applied to a list, a choice group, a menu, a scroll bar, a slider, a media control, and a programming guide. Moreover, it should be noted that any physical movement of the media controller and touchless signings can be performed in any combination for enhancing a user interface.

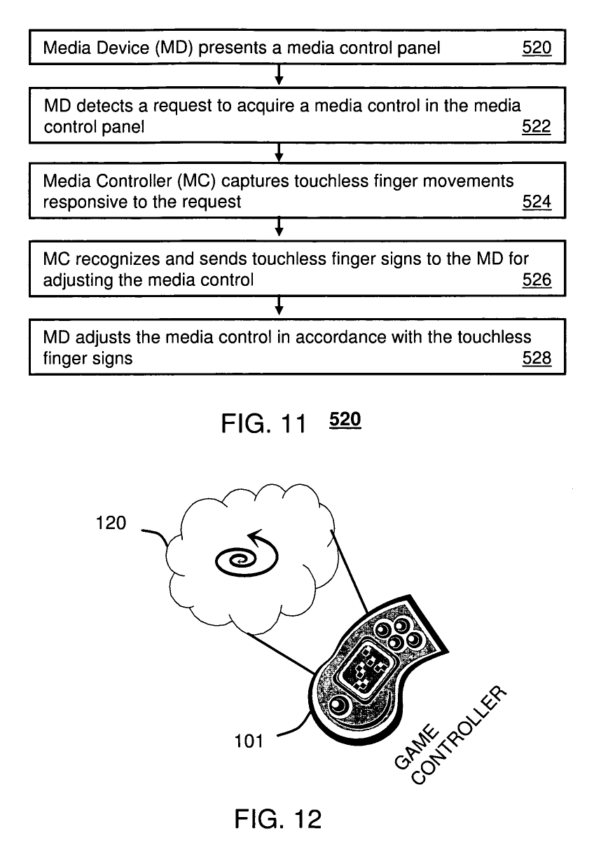

FIG. 11 presents an exemplary method 520 for sensory based media control. In particular, the method 520 provides an exemplary means for touchless media control. Reference will be made to FIG. 9 when describing the method 520. The method 520 can begin in state 522 in which a media device 130 presents a media control panel. For example, referring back to FIG. 9, the media control panel 450 can be presented responsive to a user selecting a menu item (e.g. artist name) in a media list 440. The media control panel 450, as illustrated, can perform functions for playing songs (e.g. stop, pause, play, back, forward ) and adjusting audio controls (e.g. volume, bass, treble, song selection, etc). The songs can be stored locally or remotely on a server hosted by a service provider. A service provider can provide the media (e.g. songs) responsive to the media controller 101 requesting the media item. For example, responsive to selecting an artist identified by the menu item 442 (e.g. a Beatles) in the media list 440, the user can select a song of the Artist and play the song.

At step 524 the media device 130 detects a request to acquire a media control of the media control panel. A request can be the positioning of the cursor 405 over a media control 451 (e.g. volume, bass, song) that has an associated range. A request can also be a selection of the media control 451 by way of the media controller 101 button 117. For instance, the volume control can have a range of 1 to 10, the bass control can have a range of 1 to 10, and the song control 451 can select songs by the artist (alternatively, the media list 440 can present the songs). The user may select the media control 451 for volume on the media control panel 450 by physically controlling the media controller 101 to move the cursor 450 to select the media control 451.

Upon the media controller 101 selecting the media control 451 responsive to the request, the media controller at step 526 captures touchless finger movements. For example, the user can perform a clockwise touchless finger scrolling operation (See FIG. 5) in the touchless sensing space 120 to direct the media device 130 to increase the volume, or a counter-clockwise touchless finger scrolling operation to direct the media device 130 to decrease the volume.

At step 528 the media controller recognizes and sends touchless finger signs to the media device 130. The media controller 101 can also present the touchless finger movements to the pop-up window 460. The media controller 101 can recognize the touchless finger sign in real time, with a small delay, and direct the media device 130 to perform the associated control (e.g. increase or decrease). Accordingly, at step 542 the media device 130 adjusts the media control 451 in accordance with the touchless finger movements. The media device 130 can visually show an increase in the media control 451, for example by turning the control, or showing a value of the control.

Although focus has been placed for illustration purposes on an audio media control using a combination of physical media controls (e.g. moving cursor, button presses) and touchless finger signs (e.g. letters, scrolling, selection), the method 540 can be applied in other contexts. For example, as shown in FIG. 12, the media controller 101 can control one or more aspects of a video, animation, or game. A media control can adjust the indexing speed of a video, adjust parameter values of animated characters or avatars, or adjust controls of a text processing application, a program, a database, or a graphics engine.

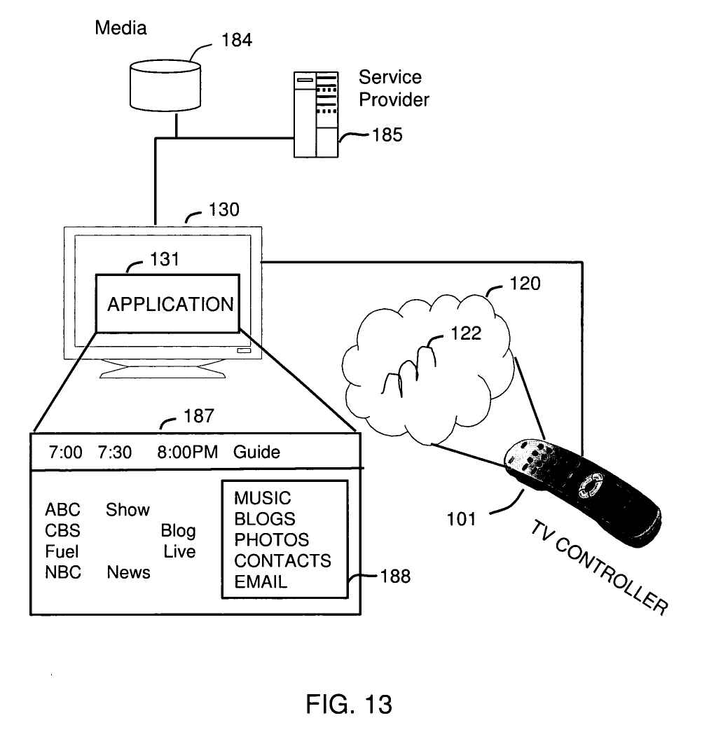

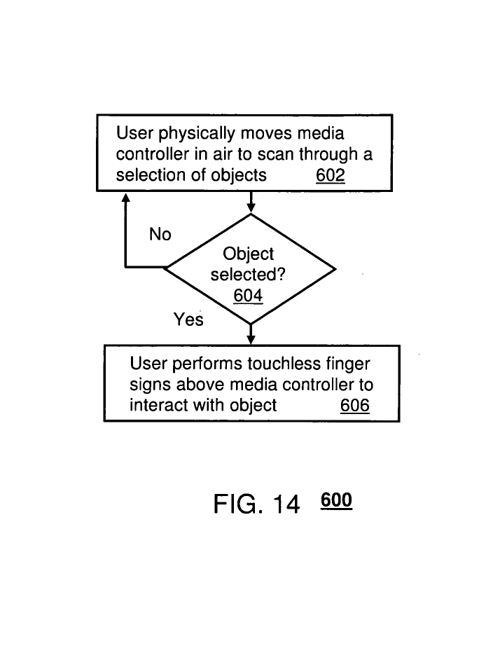

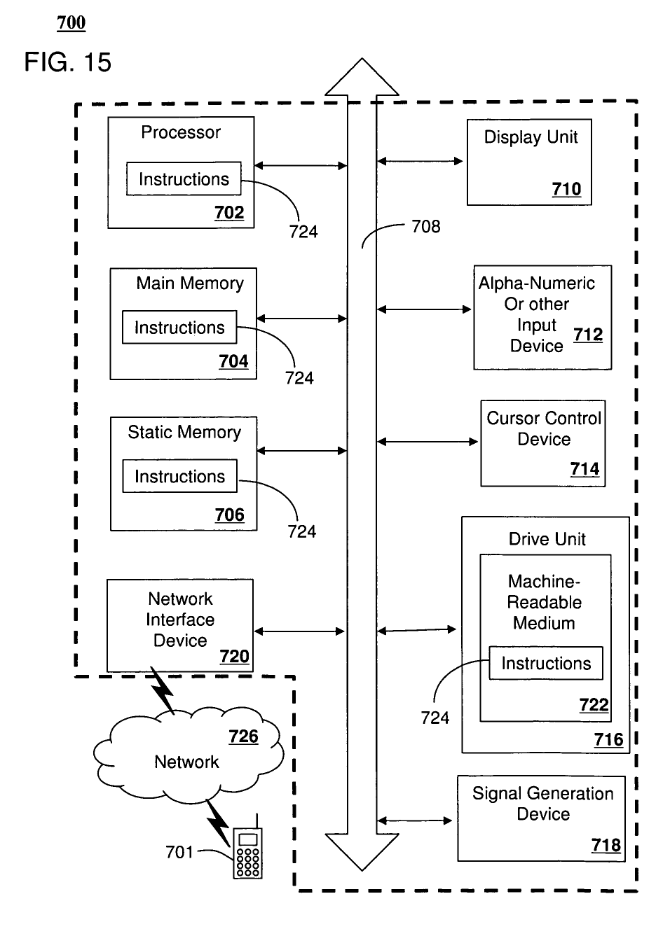

Referring to FIG. 13, an exemplary media system 100 using the media controller 101 for controlling one or more aspects of the media device 130 is shown. As illustrated, the media device 130 can be a digital television, a set-top-box, or a control guide. The media device can receive media services from a service provider 185 having access to a database 184 of media, including audio, video, and text. The media services can include cable, satellite, dial-up, and Digital Subscriber Line (DSL) programming features provided by one or more service providers of the features.

The service provider 185 can have a controller element (e.g. server) to provide a media responsive to the media controller 101 requesting the media in accordance with touchless finger movements. The controller element can host an application 131 on the media device 130 that provides an interactive user interface 187 to receive commands from the media controller 101 to control at least a portion of the application 131 in accordance with touchless finger signs captured at the media controller. The application can a web site, a gaming application, an electronic programming guide, a computer program, a word processing program, an email application, a media control panel, or a file management program.

For example, the controller element can receive at least one alpha-numeric character 122 from the media controller 101 and provide media associated with a text descriptor corresponding to the at least one alpha-numeric character. For example, the user can enter the letter “m” to list the programming channels that start with the letter m. The media controller 101 by way of the controller 210 (See FIG. 2) recognizes a letter and scrolls through the list to items having a portion of a text description corresponding to the letter. The user can also enter in numbers to select programming channels. In such regard, the controller element receives at least one alpha-numeric character from the media controller 101 and provides media having a text descriptor corresponding to the at least one alpha-numeric character. For example, the user can generate touchless finger signs for “CNN” to change to the media channel corresponding to the CNN news station.

In one arrangement, the controller 210 of the media controller 101 (see FIG. 2) detects an acceleration of the media controller by way of the accelerometer (210), selects an object 188 in accordance with the acceleration, recognizes at least one finger sign after the acceleration stops, and searches for a media in accordance with the at least one finger sign. For example, the user can physically move the controller to select a selection guide 188, and then proceed to perform touchless finger scroll signs to scroll through the guide, and a touchless up/down to select an item in the guide.

Referring to FIG. 14, a method 600 for one embodiment of touchless media selection is provided. As shown in step 602 a user physically moves the media controller 101 in air to scan through a selection of objects. For instance, the user can motion the media controller 101 in air initiate a browsing of a channel guide on a TV media device 130. As the user moves the media controller 101 in air, the media device can visually identify objects, such as channel selections, or media controls (e.g., volume, balance, etc.), or lists (e.g., channel lists, buddy lists, etc.) The user can stop the movement of the media controller 101 when an object of interest is highlighted or acquired. Responsive to the stop, or pause, touchless sensing can activate. That is, the media controller 101 can await a touchless finger sign, or a physical selection of the object (e.g., touch based button). If a finger sign is not detected, or a button is not pressed, the user can continue to physically move the media controller 101 to scan a selection of objects back at step 602.

If at step 604, the user selects the object, touchless activation commences, and the user can perform touchless finger signs above the media controller to interact with the object as shown in step 606. For instance, upon selecting a TV channel guide, the user can proceed to perform touchless circular finger movement in the touchless sensory field to scroll through the channels. The user can perform counterclockwise finger movements to scroll backwards through the list. Thus, the user can scroll through the channels without having to physically press a button on the media controller 101 or physically move the media controller 101 in air. As another example, the object can be a media control such as a volume control. Upon selection of the volume control, the user can perform touchless clockwise and counterclockwise finger movements to adjust the volume. Moreover, the user can alternatively generate a touchless “V” finger sign, to acquire control of the volume knob, instead of physically moving the media controller 101 to select the volume knob.

Upon reviewing the embodiments disclosed, it would be evident to an artisan with ordinary skill in the art that said embodiments can be modified, reduced, or enhanced without departing from the scope and spirit of the claims described below. For example, the application 131 can be a business website that lists one or more items available for sale. The website can contain a number of product categories, each having an associated pull down list for selecting products. A user accessing the website can use the media controller 101 or any derivative product incorporating the principles of touchless media control to search and select the items in accordance with the aforementioned methods. In another example, the website may be a file sharing application for video, music, games, or information. The application may contain a number of links to information sources such as blogs, other websites, download sites arranged in a list format. In yet another arrangement, the application may contain a list of email contacts, list of phone numbers, list of businesses from which a user can select using touchless finger movements. The service provider 185 in response to receiving a touchless selection of a phone number in a list, can connect the user to a media component (e.g. cell phone, VoIP terminal) corresponding to the phone number. Broadly stated, the media device 130 in response to touchless finger signs presented by the media controller 101 can perform one or more telecommunication functions.

In one embodiment a Service Provider can have a controller element to provide a media responsive to a media controller requesting the media in accordance with touchless finger movements, wherein the media is audio, video, or text. The controller element can host an application that provides an interactive user interface to receive commands from the media controller to control at least a portion of the application in accordance with touchless finger signs captured at the media controller. The controller element can receive at least one alpha-numeric character from the media controller and provides media having a text descriptor corresponding to the at least one alpha-numeric character. The application can be a web site, a gaming application, a programming guide, a computer program, a word processing program, an email application; a media control panel, a file management program, or an electronic programming guide. The object can be a text, a file, a song, an email, a voice mail, a link, and an image.

In yet another embodiment, a media device can include a controller element to receive from a media controller a first instruction to select an object in accordance with a physical handling of the media controller, and a second instruction to control the object identified in accordance with touchless finger movements. The media device can be a computer, a gaming console, or a set-top box. The object can be a list, a choice group, a menu, a scroll bar, a media control, or a programming guide. The controller element can receive a request to associate a finger sign with a macro, and assigns the macro to the finger sign.

Other suitable modifications can be made to the present disclosure and incorporating aspects of previously submitted applications. Accordingly, this application also incorporates by reference the following Provisional Applications: Attorney Docket No. B00.16 entitled “Method and System for Planar Sensory Detection”, filed on Aug. 15, 2006, U.S. Patent Application No. 60/837,685 Attorney Docket No. B00.17 entitled “Method and System for a Touchless Interface”, filed on Aug. 24, 2006, U.S. Patent Application No. 60/842,436 Attorney Docket No. B00.18 entitled “Method and Apparatus for Touchless Calibration”, filed on Sep. 5, 2006, U.S. Patent Application No. 60/842,437 Attorney Docket No. B00.19 entitled “Method and Apparatus for Touchless Control of a Device”, filed on Sep. 5, 2006, and U.S. Patent Application No. 60/855,621 Attorney Docket No. B00.20 entitled “Touchless User Interface for a Mobile Device”, filed on Oct. 31, 2006, U.S. Patent Application No. 60/865,166 Attorney Docket No. B00.21 entitled “Method and Device for Touchless Signing and Recognition”, filed on Nov. 9, 2006, and U.S. Patent Application No. 60/865,167 Attorney Docket No. B00.22 entitled “Method and Device to Control Touchless Recognition”, filed on Nov. 9, 2006, Attorney Docket No. B00.23 entitled “Method and Device for Touchless Media Searching”, filed on Mar. 19, 2007; Attorney Docket No. B00.24 entitled “Apparatus for Virtual Navigation and Voice Processing”, filed on Apr. 11, 2007. The reader is directed to the claims below, which are incorporated by reference, for a fuller understanding of the breadth and scope of the present disclosure.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

For example, FIG. 15 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a mobile device, a laptop computer, a desktop computer, a control system, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard, touch-screen), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720 to another device 701.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

While the preferred embodiments of the invention have been illustrated and described, it will be clear that the embodiments are not so limited. Numerous modifications, changes, variations, substitutions and equivalents will occur to those skilled in the art without departing from the spirit and scope of the present embodiments of the invention as defined by the appended claims.

What is claimed is:

1. A method for touchless searching, the method comprising the steps of:
recognizing touchless finger signs responsive to a request for acquiring touchless control of at least a portion of an application; and
controlling at least the portion of the application in accordance with the touchless finger signs.

2. The method of claim 1, wherein the request is activated in response to a selection of an object in the application, or a positioning of a cursor over an object in the application.

3. The method of claim 1, wherein the application is at least one among a web site, a gaming application, a programming guide, a computer program, a word processing program, an email application, a media control panel, a file management program, and an electronic programming guide.

4. The method of claim 1, further comprising computer instructions for scrolling a list in accordance with a first touchless finger sign and selecting an item in a list in accordance with a second touchless finger sign.

5. The method of claim 1, further comprising computer instructions for searching for a media in the application using a recognized finger sign responsive to recognizing the finger sign.

6. The method of claim 1, further comprising computer instructions for
selecting an object;
copying the object responsive to detecting a first touchless finger sign;
identifying an insertion point for the object; and
pasting the object at the insertion point responsive to detecting a second touchless finger sign.

7. A media controller comprising
a tracking unit to detect a physical movement of the media controller and identify a component in an application;
a sensing unit to detect touchless finger movements associated with the media controller; and
a controller to control the component in the application in accordance with the touchless finger movements.

8. The media controller of claim 7, where
the tracking component moves a cursor in accordance with a physical handling of the media controller; and
the touchless sensing unit controls an action of the cursor in accordance with the touchless finger movements.

9. The media controller of claim 7, wherein the tracking component is an optical system, an opto-electric system, an acceleration detection system, a laser system, a track ball, a stick, or a touch-pad.

10. The media controller of claim 7, wherein the touchless sensing unit projects a touchless sensing space that is within a range of movement of an index finger when a user physically handles the media controller, and detects touchless finger signs for controlling a component action.

11. The media controller of claim 7, wherein the action is at least one among a touchless scrolling, a touchless selection, and a touchless finger signing of an alphabetic or numeric character.

12. A media controller, comprising:
a sensing unit to capture touchless finger signs; and
a controller to recognize the touchless finger signs and control at least a portion of an application in accordance with the touchless finger signs.

13. The media controller of claim 12, wherein the media controller is a mouse, a remote control, a mobile device, or a game control.

14. The media controller of claim 12, wherein the controller controls a scrolling of a list in the application, a selection of an item in the list, a media control in the application, an object in the application, or a search operation in accordance with touchless finger signs.

15. The media controller of claim 12, wherein the application includes a list and the controller accesses items in the list in accordance with finger signs responsive to a selection of the list, wherein the list is at least one among a song list, an email list, a picture list, a message list, a contact list, a product list, a list of directories, and an address list.

16. The media controller of claim 12, wherein the application includes a media control panel and the controller adjusts at least one media control in accordance with the touchless finger signs responsive to a selection of the at least one media control.

17. The media controller of claim 12, wherein the finger sign is at least one among an alpha-numeric character, a clockwise circular movement, a counter-clockwise circular movement, an up/down movement, and a left/right movement.

18. The media controller of claim 12, wherein the controller recognizes a letter and scrolls through the list to items having a portion of a text description corresponding to the letter.

19. The media controller of claim 12, wherein the controller searches through a list in the application, changes channels, or adjusts a media control, in accordance with the touchless finger signs.

20. The media controller of claim 12, wherein the controller detects a movement of the media controller, selects an object in accordance with the movement, recognize at least one finger sign after the movement stops, and searches for a media in accordance with the at least one finger sign.
